(19) United States
(12) Patent Application Publication
(10) Pub. No.: US 2026/0253242 A1
(43) Pub. Date: Aug. 27, 2026

(54) Dimension Measurement System, Model Creation System, and Dimension Measurement Method

(71) Applicant: HITACHI HIGH-TECH CORPORATION, Minato-ku, Tokyo (JP)

(72) Inventors: Jun CHEN, Tokyo (JP); Ryou YUMIBA, Tokyo (JP); Yasutaka TOYODA, Tokyo (JP)

(21) Appl. No.: 18/998,293

(22) PCT Filed: Jul. 27, 2022
(86) PCT No.: PCT/JP2022/028873

§ 371 Date: Jan. 24, 2025

(51) Int. Cl. G06T 7/60; G06T 5/60; G06T 7/12

(52) U.S. Cl. CPC G06T 7/60; G06T 5/60; G06T 7/12; G06T 2207/10061; G06T 2207/20081; G06T 2207/20192; G06T 2207/30148

(57) ABSTRACT

In the present invention, a measurement-subject captured image in which a specimen is captured is converted to a measurement-subject dimension measurement image by a dimension measurement image conversion model, and the dimensions of a measurement pattern image included in the measurement-subject dimension measurement image are measured. The measurement-subject image conversion model is trained using teaching data that is a combination of a training captured image in which the specimen is captured and a training dimension measurement image that corresponds to the training captured image. The contrast between a measurement pattern image and a non-measurement pattern image present near the measurement pattern image in the training dimension measurement image is improved over the contrast between a measurement pattern image and a non-measurement pattern image in the training captured image. Alternatively, the non-measurement pattern image in the training captured image is removed from the training dimension measurement image.

### TECHNICAL FIELD

The present disclosure relates to a dimension measurement system, a model creation system, and a dimension measurement method.

### BACKGROUND ART

PTL 1 discloses an image processing method for optimizing brightness and intensity profile of a specific target region in an image. Therefore, the specific region (for example, a face of a person) is detected, a tone curve for image enhancement is calculated using a histogram of the entire image or a histogram of the specific region, and a contrast correction is performed using the calculated tone curve.

PTL 2 discloses a learnable model capable of selectively converting, with high accuracy, a partial image such as a specific pattern included in an image or an edge of a structure other than the specific pattern. By adjusting the weight of learning based on a degree of importance of each part of the image, the learnable model can generate high-quality images in critical areas while reducing the processing required for learning in less significant areas, thereby improving learning efficiency.

### CITATION LIST

### Patent Literature

PTL 1: JP2009-200743A

PTL 2: WO2021/140620

### SUMMARY OF INVENTION

### Technical Problem

Technical problems addressed by the present disclosure will be described with reference to FIG. 1A. A captured image (schematic diagram) is shown in the left column. The captured image 100 is, for example, an SEM image of a pattern formed on a semiconductor wafer. In the vicinity of a first pattern that is a measurement target, a second pattern that is not a measurement target is provided on the semiconductor wafer. A luminance profile 111 along a line 103 the captured image 100 is shown in the right column. In addition to the luminance profile 111, a luminance profile 112, representing the scenario where the second pattern is absent, is also shown.

If the first pattern is an isolated pattern, there is a high contrast with its surroundings as shown in the luminance profile 112, and it can be expected that edge extraction from a first pattern image (a measurement pattern image) 101 for measurement is also performed at high accuracy. In contrast, when the captured image 100 includes a non-measurement pattern in the vicinity of a measurement pattern, by being influenced by a second pattern image (a non-measurement pattern image) 102, the luminance in a boundary region between the first pattern and the second pattern does not decrease as in the case of the isolated pattern, and a luminance representing the first pattern image 101 does not decrease completely and is connected to a luminance representing the second pattern image 102, resulting in a luminance distribution like the luminance profile 111. In this case, the accuracy of the edge extraction from the first pattern image 101 for measurement decreases, and as a result, the measurement accuracy also decreases.

When the technique disclosed in PTL 1 is applied to the captured image shown in FIG. 1A, the first pattern image 101 is visualized and the second pattern image 102 is also visualized, so that the above technical problems cannot be solved. Further, even when the accuracy is differeciated between the important portion and non-important portion in PTL 2, the above technical problems cannot be solved because processing of enhancing a difference in the contrast is not performed.

In the present disclosure, to perform dimension measurement of a pattern from a captured image, the captured image 100 is converted into a dimension measurement image 120 for dimension measurement as shown in FIG. 1B as a schematic diagram. The dimension measurement image 120 is an image in which the contrast of the first pattern image 121, which is a measurement pattern image, with respect to the second pattern image 122, which is a non-measurement pattern image, is improved compared to the original captured image 100. For example, the dimension measurement image 120 may be an image in which the second pattern image 122, which is the non-measurement pattern image, is removed. Alternatively, the dimension measurement image 120 may be an image in which the contrast of the second pattern image 122 with a background portion (a region other than the first pattern image 121 and the second pattern image 122 in the dimension measurement image 120) of the dimension measurement image 120 is reduced.

### Solution to Problem

A dimension measurement system according to an aspect of the present disclosure is a dimension measurement system for performing dimension measurement of a pattern formed on a sample, and the dimension measurement system includes: a computer system including a dimension measurement image conversion unit and a dimension measurement unit, in which the dimension measurement image conversion unit converts a measurement target captured image obtained by capturing an image of the sample into a measurement target dimension measurement image by a dimension measurement image conversion model, the dimension measurement unit measures a dimension of a measurement pattern image included in the measurement target dimension measurement image, the dimension measurement image conversion model is learned using labeled training data that is a combination of a learning captured image obtained by capturing an image of the sample and a learning dimension measurement image corresponding to the learning captured image, and a contrast between the measurement pattern image and a non-measurement pattern image present in vicinity of the measurement pattern image in the learning dimension measurement image is improved compared to a contrast between the measurement pattern image and the non-measurement pattern image in the learning captured image, or in the learning dimension measurement image, the non-measurement pattern image in the learning captured image is removed.

### Advantageous Effects of Invention

Erroneous measurement in dimension measurement is reduced. Other technical problems and novel features will become apparent from the description of the present specification and the accompanying drawings.

### BRIEF DESCRIPTION OF DRAWINGS

FIG. 1A is a diagram showing a technical problem addressed by the present disclosure.

FIG. 1B is a diagram showing the technical problem addressed by the present disclosure.

FIG. 2 is a configuration example of a dimension measurement system.

FIG. 3 is a configuration example of a model creation system.

FIG. 4A is a functional block diagram of an image generation model creation unit.

FIG. 4B is an example of a generation model confirmation screen.

FIG. 5 is a functional block diagram of a region segmentation unit.

FIG. 6A is a functional block diagram of a dimension measurement edge detection unit.

FIG. 6B is a diagram showing how an edge is detected by applying interactive machine learning.

FIG. 7 is a functional block diagram of an image conversion model creation unit.

FIG. 8 is a diagram showing a region designation method.

FIG. 9A is an example of a label image.

FIG. 9B is an example of a dimension measurement image generated from the label image of FIG. 9A.

FIG. 10A is an example of a region designation screen.

FIG. 10B is an example of a manual designation screen.

FIG. 10C is an example of an automatic designation screen.

FIG. 11 is an example of a conversion model confirmation screen.

FIG. 12 is a functional block diagram of a dimension measurement image conversion unit.

### DESCRIPTION OF EMBODIMENTS

FIG. 2 is a diagram showing a configuration example of a dimension measurement system. The dimension measurement system of FIG. 2 is a system that performs dimension measurement processing on a pattern formed on a semiconductor wafer using a charged particle beam device such as a scanning electron microscope (SEM). The dimension measurement system acquires an image of a fine pattern formed on a semiconductor wafer and performs dimension measurement. The dimension measurement system includes an SEM 11, a control device 12 that controls the SEM 11, a computer system 1 that executes the dimension measurement processing, an input device 13 that inputs necessary information to the computer system 1, and a display 14 that displays an information input screen, a measurement result, and the like.

The computer system 1 includes a storage device 3 and an arithmetic processing unit 2 including one or more central processing units (CPUs). In the present disclosure, the storage device 3 stores a program related to the dimension measurement processing, another program related to control of the SEM, data used by the programs for processing, such as a dimension measurement image conversion model 31 and a dimension measurement recipe 32 to be described later, and processing results by these programs. The computer system 1 may be configured integrally with the control device 12.

The arithmetic processing unit 2 executes the program related to the dimension measurement processing, thereby executing the dimension measurement processing. That is, the computer system 1 functions as a dimension measurement processing device. In other words, the program causes the computer system to function as the dimension measurement processing device. The programs executed by the computer system 1 and functions thereof are referred to as “functions” , “unit”, and the like.

The arithmetic processing unit 2 functions as a captured image input unit 21 that is an interface for receiving a captured image by the SEM 11, a dimension measurement image conversion unit 22 that converts the captured image received by the captured image input unit 21 into a dimension measurement image, and a dimension measurement unit 23 that performs, according to the dimension measurement recipe 32, the dimension measurement on the dimension measurement image created by the dimension measurement image conversion unit 22. When the dimension measurement image conversion unit 22 converts the captured image into the dimension measurement image, the dimension measurement image conversion model 31 is used.

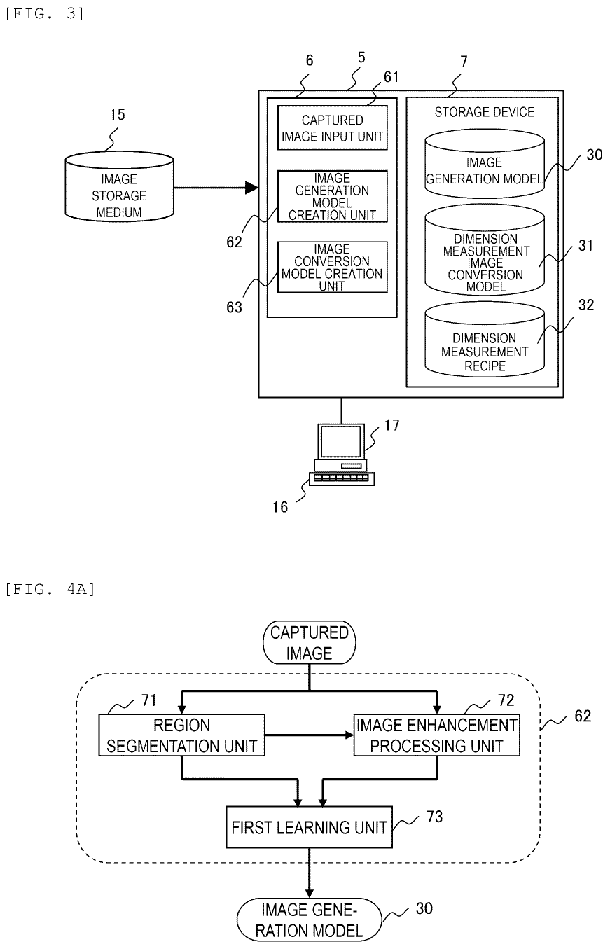

FIG. 3 is a diagram showing a configuration example of a model creation system that creates the dimension measurement image conversion model 31 used by the dimension measurement system.

The computer system 5 functions as a captured image input unit 61 that is an interface for receiving the captured image, an image generation model creation unit 62 that generates an image generation model 30 using the captured image received by the captured image input unit 61 as labeled training data, and an image conversion model creation unit 63 that creates the dimension measurement image conversion model 31 by using the captured image received by the captured image input unit 61 as the labeled training data and using the image generation model 30. An image storage medium 15 stores the captured image of the semiconductor wafer, which is a measurement target captured by the SEM 11 of the dimension measurement system. A hardware structure of the computer system 5 is the same as a hardware structure of the computer system 1, and a duplicated description will be omitted. An input device 16 and a display 17 are connected to the computer system 5.

If there are sufficient arithmetic resources, processing in the computer system 5 can be executed in the computer system 1 in the dimension measurement system. Conversely, while FIG. 3 shows an example in which the captured image used as the labeled training data is stored in the image storage medium 15, it is also possible to connect the image storage medium 15 to the computer system 1 to form a dimension measurement system that performs the dimension measurement of the captured image stored in image storage medium 15.

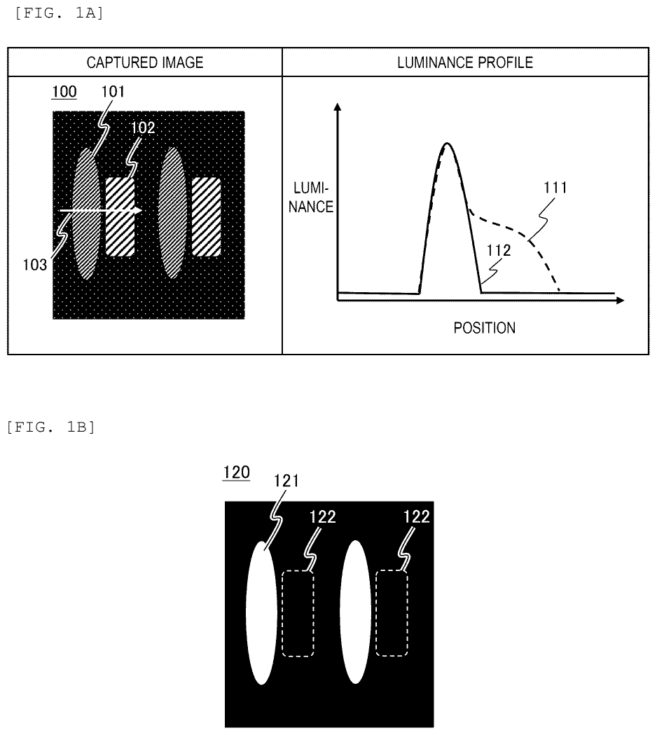

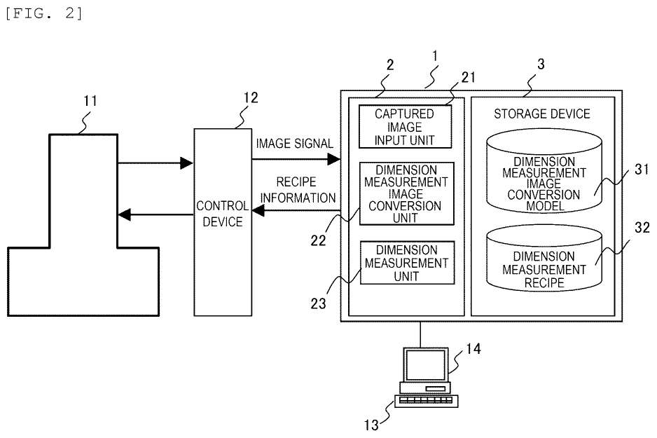

First, the creation of the model by the model creation system will be described. The model creation system creates a dimension measurement image conversion model that converts the captured image as shown in FIG. 1A into the dimension measurement image as shown in FIG. 1B. Therefore, the labeled training data which is a combination of the captured image and the dimension measurement image is created.

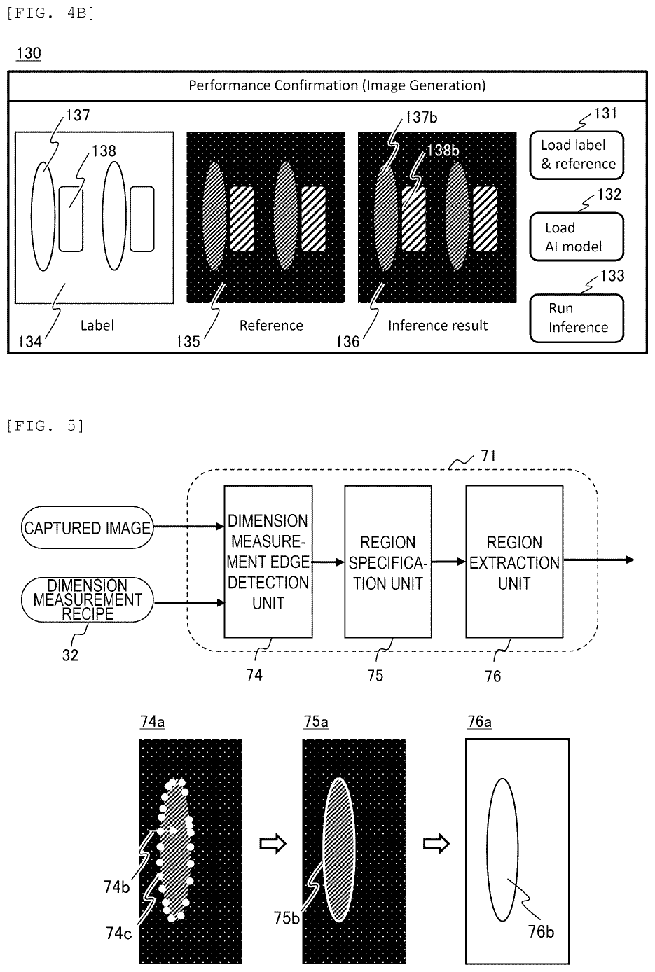

FIG. 4A is a functional block diagram of the image generation model creation unit 62. The image generation model creation unit 62 is a functional block for creating the image generation model 30. The image generation model 30 is a model that generates, from a label image indicating a shape of a pattern region, an image (hereinafter, may be referred to as a pseudo image) that has the shape indicated by the label image and is regarded as a real image. As to be described later, the image generation model 30 is used in a process of creating the dimension measurement image used for the labeled training data. The image generation model creation unit 62 includes a region segmentation unit 71, an image enhancement processing unit 72, and a first learning unit 73.

The region segmentation unit 71 segments the captured image into a measurement pattern region and another background region. In the case of the example of FIG. 1A, the captured image is segmented into the measurement pattern region corresponding to the first pattern image (the measurement pattern image) 101 and another background region. Such a region segmentation may use any method, for example, may be manually performed, may be performed by image processing, or may be performed in a combination thereof, that is, a user verifies and corrects the region segmentation performed by the image processing. As a method for performing the region segmentation image processing, a method using image features (clustering of luminance by k-means method), a method using machine learning (supervised and unsupervised segmentation), and the like are known, and these methods can be applied. Here, since it is sufficient to extract only the measurement pattern region, region segmentation processing using a dimension measurement recipe for performing the dimension measurement of the measurement pattern image will be described. The dimension measurement recipe 32 is data representing dimension measurement conditions of the measurement pattern image, and a shape (for example, a line, a hole, an ellipse, or a circle) of a measurement pattern, a dimension measurement cursor (for example, coordinates, width, length, or number of an upper left vertex), a measurement algorithm, a dimension measurement parameter, and the like are registered therein.

FIG. 5 is a functional block diagram of the region segmentation unit 71 that performs the region segmentation processing using the dimension measurement recipe 32. The region segmentation unit 71 includes a dimension measurement edge detection unit 74, a region specification unit 75, and a region extraction unit 76. Schematic diagrams 74a, 75a, and 76a are schematic diagrams showing processing results in these functional blocks. The dimension measurement edge detection unit 74 detects an edge 74c of the captured image using the dimension measurement recipe 32. In a processing result 74a, the edge 74c is displayed by white circles. The edge 74c can be extracted, for example, as a change point of a luminance profile along a line 74b. However, as shown in FIG. 1A, a change in the luminance profile of the pattern image may become unclear due to presence of a nearby pattern. Therefore, the dimension measurement edge detection unit 74 can detect the edge 74c at high accuracy using a deep learning method. Details thereof will be described below. The region specification unit 75 interpolates and connects the nearby edges 74c to specify a pattern boundary 75b as shown in a processing result 75a. The region extraction unit 76 specifies the measurement pattern region based on the pattern boundary 75b specified by the region specification unit 75. In the processing result 76a, a region 76b corresponding to a region surrounded by the pattern boundary 75b is the measurement pattern region. Accordingly, the label image indicating the measurement pattern region corresponding to the measurement pattern image included in the captured image is obtained. When there is a plurality of measurement pattern regions in the captured image, extraction of the measurement pattern region may be performed on each of the measurement pattern regions.

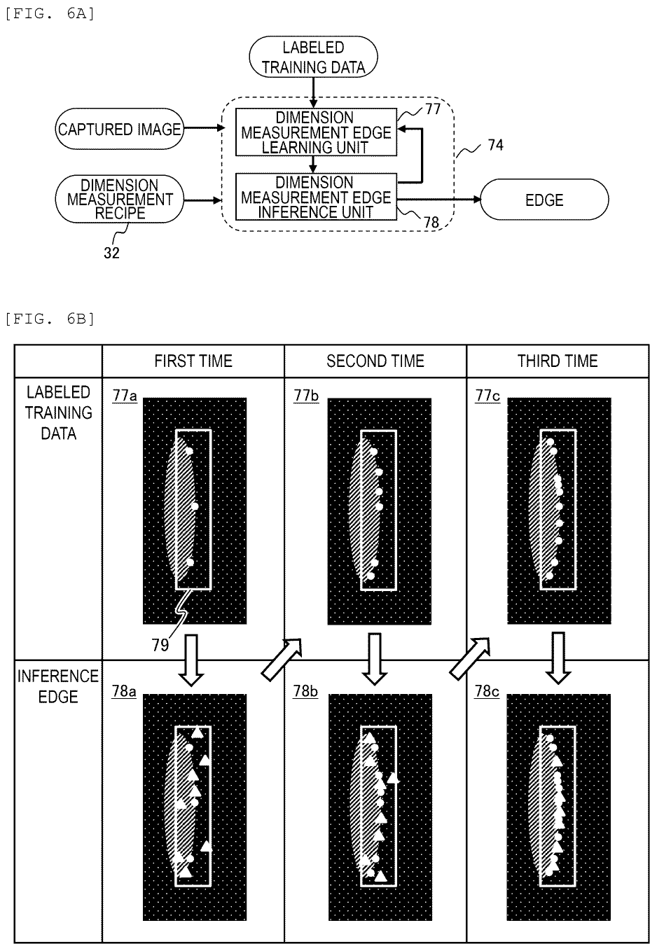

FIG. 6A is a functional block diagram of the dimension measurement edge detection unit 74 that detects the edge from the captured image. The dimension measurement edge detection unit 74 includes a dimension measurement edge learning unit 77 and a dimension measurement edge inference unit 78, and enables detection of the edge at high accuracy by an interactive machine learning method. The dimension measurement edge learning unit 77 learns a learnable model that infers the edge using the labeled training data, and the dimension measurement edge inference unit 78 performs inference of the edge using the learnable model learned by the dimension measurement edge learning unit 77.

FIG. 6B shows how the dimension measurement edge detection unit 74 detects the edge by applying interactive machine learning. white frame 79 in the drawing is a dimension measurement cursor, and a change point of the luminance profile in this region is detected as an edge. Details of detection processing are defined in the dimension measurement recipe 32. Here, white circles indicate an edge which is the labeled training data, and white triangles indicate an edge inferred using the learnable model.

First labeled training data 77a is given by the user. The result of inference by the learnable model obtained by learning the first labeled training data 77a is an inference edge 78a. The inference edge 78a includes an inference result located on the pattern boundary and an inference result deviating from the pattern boundary. Therefore, the user removes the inference result deviating from the pattern boundary and sets the inference result located on the pattern boundary and the initially given labeled training data as new labeled training data 77b. Similarly, an inference edge 78b is obtained as a result of inference by a learnable model obtained by learning the labeled training data 77b. This work is repeatedly executed, and finally, when a result of inference by the learnable model converges on the pattern boundary (here, a third inference edge 78c), the learning of the learnable model is ended.

As described above, the region segmentation unit 71 can generate the label image indicating a region corresponding to the measurement pattern image from the captured image.

Returning to the description of FIG. 4A. The first learning unit 73 learns the image generation model 30 using a combination, as the labeled training data, of the label image indicating the measurement pattern region and generated by the region segmentation unit 71 and the measurement pattern image of the captured image. When an error between a pseudo measurement pattern image generated by the image generation model 30 and the measurement pattern image of the original captured image converges to a certain level or less, the learning of the image generation model 30 is ended. To enhance the accuracy of the model by increasing the number of labeled training data, it is possible to apply a known data augmentation method for increasing the number of labeled training data as well as increasing the number of captured images.

In this case, in the pseudo measurement pattern image generated by the image generation model 30, a shape follows the shape of the pattern region of the label image, while an image equivalent to the original captured image is output as an image. In contrast, for example, an image in which a luminance of the generated pseudo measurement pattern image is improved compared to the original captured image may be output. In this case, an image obtained by performing the image processing on the captured image such that the measurement pattern region is emphasized by the image enhancement processing unit 72 may be used as the labeled training data used in the first learning unit 73. The first learning unit 73 may learn a learnable model that outputs the label image indicating the region corresponding to the measurement pattern image from the captured image, and the image generation model 30 may output the pseudo image based on a brightness of pixels of places corresponding to a label output to the captured image using the learnable model that outputs the label image and a label output in the captured image. The first learning unit 73 may learn a plurality of types of measurement pattern images with one image generation model, for example, for reasons such as consolidating the number of image generation models 30 stored in the storage device 7. For example, in the example of FIG. 1A, the first pattern image 101 and the second pattern image 102 may be collectively learned by one image generation model 30. The image generation model 30 for which the learning is ended is stored in the storage device 7.

The image generation model creation unit 62 may include a graphical user interface (GUI) for confirming a performance of the created image generation model 30. FIG. 4B shows an example of a generation model confirmation screen 130. When the user presses a label image and reference image load button 131 in the generation model confirmation screen 130, the captured image and the label image created by performing the region segmentation on the captured image are read and displayed as a reference image 135 and a label image 134, respectively. In this example, two types of measurement pattern images are present in the reference image 135. When the user presses an AI model load button 132, a corresponding image generation model is loaded. For example, a first image generation model for a first measurement pattern region 137 and a second image generation model for a second measurement pattern region 138 are loaded. Thereafter, when the user presses an execution button 133, a pseudo measurement pattern image 137b is generated from a label image indicating the first measurement pattern region 137 using the first image generation model, and a pseudo measurement pattern image 138b is generated from a label image indicating the second measurement pattern region 138 using the second image generation model. A generated pseudo image 136 is displayed alongside the reference image 135. By comparing a measurement pattern image of the reference image 135 with a pseudo measurement pattern image of the generated pseudo image 136, the user can confirm that an appropriate pseudo measurement pattern image is generated.

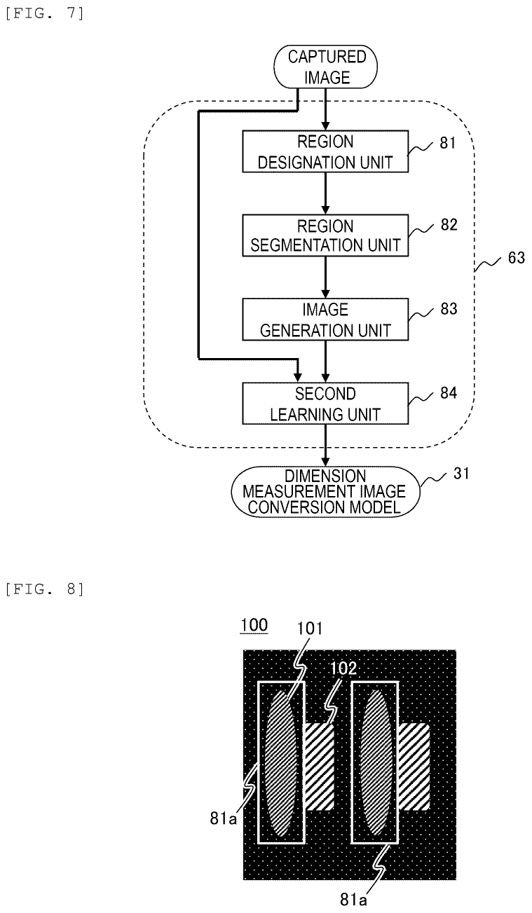

FIG. 7 is a functional block diagram of the image conversion model creation unit 63. The image conversion model creation unit 63 is a functional block for creating the dimension measurement image conversion model 31. The image conversion model creation unit 63 includes a region designation unit 81, a region segmentation unit 82, an image generation unit 83, and a second learning unit 84. The region designation unit 81, the region segmentation unit 82, and the image generation unit 83 create a dimension measurement image serving as training data for the dimension measurement image conversion model 31.

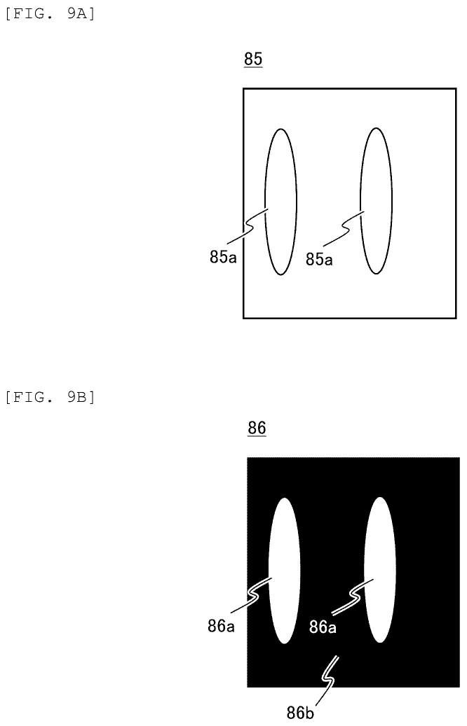

The region designation unit 81 designates a region including the measurement pattern image from the captured image. A region designation method is any method. The user may manually perform region designation by a designation box 81a shown in FIG. 8. The region designation may be performed using coordinate information of a dimension measurement cursor defined in the dimension measurement recipe. Alternatively, the region designation may be performed using a layout design diagram of a device and performing expansion processing on a layout of a corresponding pattern.

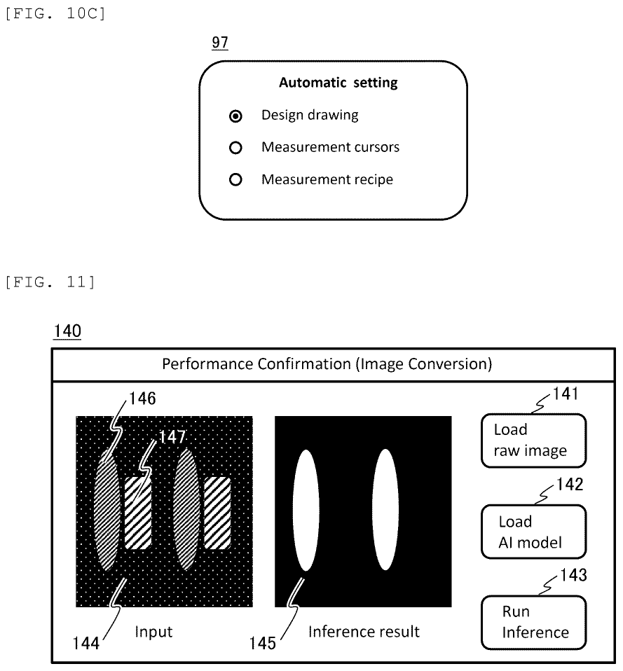

FIG. 10A shows an example of a GUI for performing the region designation. A captured image to be subjected to region designation processing is selected from an image load button 91 of a region designation screen 90 and is displayed as a captured image 94. A designation box 95 indicating a region to be designated is displayed on the captured image 94, and coordinates and a dimension of the designation box 95 are determined. The user presses a manual designation button 92 when manually performing the designating, and presses an automatic designation button 93 when automatically performing the designation by the dimension measurement recipe or other information. By pressing the manual designation button 92, a manual designation screen 96 as shown in FIG. 10B is displayed. In the manual designation screen 96, a shape, the coordinates, and a size of the designation box 95 can be designated. The dimension of the designation box 95 displayed on the captured image 94 can also be adjusted. Visibility of the designated region can be adjusted to be enhanced or reduced. In contrast, when the automatic designation button 93 is pressed, an automatic designation screen 97 as shown in FIG. 10C is displayed. For example, if a plurality of automatic designation methods can be used, the user can select an automatic designation method to be applied.

The region designation on the region designation screen 90 is not limited to a rectangular shape shown as the designation box 95, may use another shape such as an ellipse, or may be in other designation forms such as center coordinates of a region. In such a case, the region designation screen 90 includes a GUI corresponding to a region designation form. Alternatively, on the region designation screen 90, the label image 134 (see FIG. 4B) may be obtained from the captured image and displayed to the user, and the user may operate the GUI to designate, for example, the first measurement pattern region 137 in the label image 134.

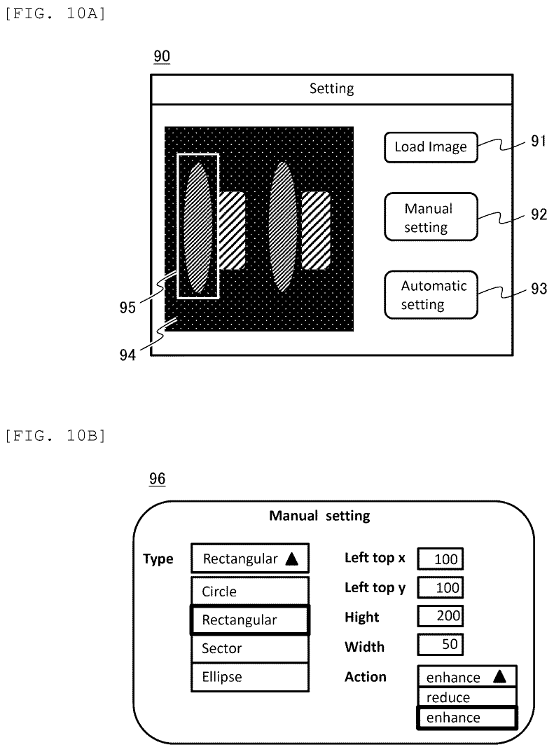

Returning to the description of FIG. 7. The region segmentation unit 82 segments the regions in the captured image subjected to the region designation into the measurement pattern region and the other regions. Since processing of the region segmentation unit 82 is the same as the processing of the region segmentation unit 71 described with reference to FIG. 4A, a redundant description will be omitted. As the region segmentation processing, when the region segmentation processing is performed using the dimension measurement recipe, the captured image may be directly subjected to the region segmentation without performing the region designation by the region designation unit 81. A label image 85 shown in FIG. 9A is obtained by the processing of the region segmentation unit 82. The label image 85 is an image obtained by performing the region segmentation processing on the captured image 100 shown in FIG. 8 and includes two measurement pattern regions 85a.

The image generation unit 83 generates the pseudo captured image corresponding to the dimension measurement image corresponding to the captured image by using the label image 85 generated by the region segmentation unit 82 and the image generation model 30. FIG. 9B shows an example of a dimension measurement image 86 that corresponds to the captured image 100 and is generated from the label image 85. A measurement pattern image 86a is a pseudo measurement pattern image generated for the measurement pattern region 85a by the image generation model 30, and for example, a background 86b is a uniform monochromatic image. The invention is not limited thereto, and luminance of a region other than the measurement pattern region 85a of the original captured image 100 may be reduced to synthesize with the pseudo measurement pattern image. That is, it is sufficient that the dimension measurement image 86 is an image in which a contrast of the pseudo measurement pattern image is improved compared to a contrast of the measurement pattern image 101 in the original captured image 100.

For example, in the dimension measurement image 86, the image generation unit 83 may perform adjustment to reduce the luminance of the region other than the measurement pattern region 85a of the original captured image 100 while increasing the luminance in the measurement pattern region 85a, and may combine these two. In this case, the contrast of the measurement pattern image 86a in the dimension measurement image 86 is significantly improved compared to the contrast of the measurement pattern image 101 in the original captured image 100. The adjustment for increasing the luminance in the measurement pattern region 85a may be performed by allowing the user to operate a GUI such as the region designation screen 90 to determine how much the luminance is increased, and the like.

The second learning unit 84 learns the dimension measurement image conversion model 31 using the combination of the captured image and the dimension measurement image generated by the image generation unit 83 as the labeled training data. When an error between the dimension measurement image generated by the dimension measurement image conversion model 31 and the dimension measurement image generated by the image generation unit 83 converges to a certain level or less, the learning of the dimension measurement image conversion model 31 is ended. To enhance the accuracy of the model by increasing the number of labeled training data, it is possible to apply a known data augmentation method for increasing the number of labeled training data as well as increasing the number of captured images.

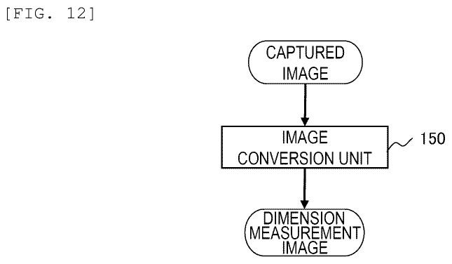

The image conversion model creation unit 63 may include a GUI for confirming a performance of the created dimension measurement image conversion model 31. FIG. 11 shows an example of a conversion model confirmation screen 140. When the user presses a captured image load button 141 in the conversion model confirmation screen 140, the captured image is read and displayed as an input image 144. In this example, a measurement pattern image 146 and a non-measurement pattern image 147 close thereto are present in the input image 144. When the user presses an AI model load button 142, the dimension measurement image conversion model is loaded. Thereafter, when the user presses an execution button 143, a dimension measurement image 145 obtained by converting the input image 144 by the dimension measurement image conversion model is displayed. The user can confirm that an appropriate dimension measurement image is generated by comparing the input image 144 with the dimension measurement image 145 obtained by the conversion.

Next, the dimension measurement processing by the dimension measurement system will be described. The storage device 3 of the computer system 1 of the dimension measurement system stores the dimension measurement recipe 32 and the dimension measurement image conversion model 31 for which the learning is ended (see FIG. 2). The control device 12 uses information in the dimension measurement recipe 32 read from the computer system 1 to acquire, for example, the image of the semiconductor wafer by the SEM 11. The captured image which is captured by the SEM 11 is input from the control device 12 to the computer system 1 by the captured image input unit 21.

FIG. 12 Shows a functional block diagram of the dimension measurement image conversion unit 22. The dimension measurement image conversion unit 22 includes an image conversion unit 150. The image conversion unit 150 uses the dimension measurement image conversion model 31 to convert the captured image as shown in FIG. 1A into the dimension measurement image as shown in FIG. 1B. Thereafter, the dimension measurement unit 23 performs the dimension measurement on the dimension measurement image converted by the dimension measurement image conversion unit 22 according to the content defined in the dimension measurement recipe 32, and even when a non-measurement pattern image that prevents the dimension measurement is present in the vicinity of the measurement pattern image, it is possible to prevent erroneous measurement because the contrast of the measurement pattern image with respect to the non-measurement pattern image is improved compared to the original captured image in the dimension measurement image. By performing the image conversion using the dimension measurement image conversion model in which the machine learning is performed for the dimension measurement image, high-speed and automatic image conversion is possible.

The present disclosure is not limited to the embodiment described above and includes various modifications. For example, the embodiment described above has been described in detail to facilitate understanding of the present disclosure, and the present disclosure is not necessarily limited to those including all the configurations described above. A part of a configuration of a certain embodiment can be replaced with a configuration of another embodiment, and a configuration of another embodiment can be added to a configuration of a certain embodiment. A part of a configuration of each embodiment may be added to, removed from, or replaced with another configuration.

### REFERENCE SIGNS LIST

1, 5: computer system
2, 6: arithmetic processing unit
3, 7: storage device
11: SEM
12: control device
13, 16: input device
14, 17: display
15: image storage medium
21: captured image input unit
22: dimension measurement image conversion unit
23: dimension measurement unit
30: image generation model
31: dimension measurement image conversion model
32: dimension measurement recipe
61: captured image input unit
62: image generation model creation unit
63: image conversion model creation unit
71: region segmentation unit
72: image enhancement processing unit
73: first learning unit
74: dimension measurement edge detection unit
75: region specification unit
76: region extraction unit
74a 75a, 76a: processing result
74b: line
74c: edge
75b: pattern boundary
76b: measurement pattern region
77: dimension measurement edge learning unit 78: dimension measurement edge inference unit
77a, 77b, 77c: labeled training data
78a, 78b, 78c: inference edge
81: region designation unit
82: region segmentation unit
83: image generation unit
84: second learning unit
81a: designation box
85: label image
85a: measurement pattern region
86: dimension measurement image
86a: measurement pattern image
86b: background
90: region designation screen
91: image load button
92: manual designation button
93: automatic designation button
94: captured image
95: designation box
96: manual designation screen
97: automatic designation screen
100: captured image
101: first pattern image (measurement pattern image)
102: second pattern image (non-measurement pattern image)
103: line
111, 112: luminance profile
120: dimension measurement image
121: first pattern image
122: second pattern image
130: generation model confirmation screen
131: label image and reference image load button
132: AI model load button
133: execution button
134: label image
135: reference image
136: pseudo image
137: first measurement pattern region
137b: first pseudo measurement pattern image
138: second measurement pattern region
138b: second pseudo measurement pattern image
140: conversion model confirmation screen
141: captured image load button
142: AI model load button
143: execution button
144: input image
145: dimension measurement image
146: measurement pattern image
147: non-measurement pattern image
150: image conversion unit

1. A dimension measurement system for performing dimension measurement of a pattern formed on a sample, the dimension measurement system comprising:
a computer system including a dimension measurement image conversion unit and a dimension measurement unit, wherein
the dimension measurement image conversion unit converts a measurement target captured image obtained by capturing an image of the sample into a measurement target dimension measurement image by a dimension measurement image conversion model,
the dimension measurement unit measures a dimension of a measurement pattern image included in the measurement target dimension measurement image,
the dimension measurement image conversion model is learned using labeled training data that is a combination of a learning captured image obtained by capturing an image of the sample and a learning dimension measurement image corresponding to the learning captured image, and
a contrast between the measurement pattern image and a non-measurement pattern image present in vicinity of the measurement pattern image in the learning dimension measurement image is improved compared to a contrast between the measurement pattern image and the non-measurement pattern image in the learning captured image, or in the learning dimension measurement image, the non-measurement pattern image in the learning captured image is removed.

2. The dimension measurement system according to claim 1, further comprising:
a charged particle beam device configured to capture an image of the sample, wherein
the computer system includes a captured image input unit configured to receive a captured image captured by the charged particle beam device.

3. A model creation system for creating a dimension measurement image conversion model configured to convert a captured image obtained by capturing an image of a sample on which a pattern is formed into a dimension measurement image, the model creation system comprising:
a computer system including an image conversion model creation unit, wherein
the image conversion model creation unit includes a region segmentation unit, an image generation unit, and a learning unit,
the region segmentation unit of the image conversion model creation unit creates a label image segmented into a measurement pattern region that is a region of a measurement pattern image included in the captured image and a background region other than the measurement pattern region,
the image generation unit of the image conversion model creation unit creates a pseudo captured image in which a pseudo measurement pattern image is generated in the measurement pattern region of the label image,
the learning unit of the image conversion model creation unit learns the dimension measurement image conversion model using labeled training data that is a combination of the captured image and the pseudo captured image, and
a contrast between the pseudo measurement pattern image and a non-measurement pattern image present in the background region and in vicinity of the pseudo measurement pattern image in the pseudo captured image is improved compared to a contrast between the measurement pattern image and the non-measurement pattern image in the captured image, or in the pseudo captured image, the non-measurement pattern image in the captured image is removed.

4. The model creation system according to claim 3, wherein
the region segmentation unit of the image conversion model creation unit includes a dimension measurement edge detection unit, a region specification unit, and a region extraction unit,
the dimension measurement edge detection unit detects an edge of the measurement pattern image,
the region specification unit specifies a pattern boundary of the measurement pattern image by interpolating the detected edge, and
the region extraction unit extracts a region surrounded by the specified pattern boundary as the measurement pattern region.

5. The model creation system according to claim 4, wherein
the computer system stores a dimension measurement recipe that is data representing a dimension measurement condition of the measurement pattern image,
the dimension measurement edge detection unit includes a dimension measurement edge learning unit and a dimension measurement edge inference unit, and detects an edge of the measurement pattern image in a dimension measurement cursor defined in the dimension measurement recipe by interactive machine learning,
the dimension measurement edge learning unit learns a learnable model by labeled training data indicating an edge of the measurement pattern image,
the dimension measurement edge inference unit performs inference of the edge of the measurement pattern image in the dimension measurement cursor by the learnable model, and
the dimension measurement edge learning unit learns the learnable model by deleting, from among edges of the measurement pattern image inferred by the learnable model, an edge of the measurement pattern image that deviates from a boundary of the measurement pattern image to obtain new labeled training data.

6. The model creation system according to claim 3, wherein
the image conversion model creation unit further includes a region designation unit configured to designate a region in which the measurement pattern image included in the captured image is present.

7. The model creation system according to claim 3, wherein
the computer system further includes an image generation model creation unit, and
the image generation unit of the image conversion model creation unit creates the pseudo measurement pattern image in the measurement pattern region of the label image by an image generation model created by the image generation model creation unit.

8. The model creation system according to claim 7, wherein
the image generation model creation unit includes a region segmentation unit and a learning unit,
the region segmentation unit of the image generation model creation unit generates a label image segmented into a measurement pattern region that is a region of the measurement pattern image included in the captured image and a background region other than the measurement pattern region, and
the learning unit of the image generation model creation unit learns the image generation model using labeled training data that is a combination of the label image and the captured image or an image obtained by performing image processing of emphasizing the measurement pattern image on the captured image.

9. The model creation system according to claim 8, wherein
the region segmentation unit of the image generation model creation unit includes a dimension measurement edge detection unit, a region specification unit, and a region extraction unit,
the dimension measurement edge detection unit detects an edge of the measurement pattern image,
the region specification unit specifies a pattern boundary of the measurement pattern image by interpolating the detected edge, and
the region extraction unit extracts a region surrounded by the specified pattern boundary as the measurement pattern region.

10. The model creation system according to claim 9, wherein
the computer system stores a dimension measurement recipe that is data representing a dimension measurement condition of the measurement pattern image,
the dimension measurement edge detection unit includes a dimension measurement edge learning unit and a dimension measurement edge inference unit, and detects an edge of the measurement pattern image in a dimension measurement cursor defined in the dimension measurement recipe by interactive machine learning,
the dimension measurement edge learning unit learns a learnable model by labeled training data indicating an edge of the measurement pattern image,
the dimension measurement edge inference unit performs inference of the edge of the measurement pattern image in the dimension measurement cursor by the learnable model, and
the dimension measurement edge learning unit learns the learnable model by deleting, from among edges of the measurement pattern image inferred by the learnable model, an edge of the measurement pattern image that deviates from a boundary of the measurement pattern image to obtain new labeled training data.

11. A dimension measurement method for performing, by a dimension measurement system including a computer system, dimension measurement of a pattern formed on a sample, the computer system including a dimension measurement image conversion unit and a dimension measurement unit, the dimension measurement method comprising:
converting, by the dimension measurement image conversion unit, a measurement target captured image obtained by capturing an image of the sample into a measurement target dimension measurement image by a dimension measurement image conversion model; and
measuring, by the dimension measurement unit, a dimension of a measurement pattern image included in the measurement target dimension measurement image, wherein
the dimension measurement image conversion model is learned using labeled training data that is a combination of a learning captured image obtained by capturing an image of the sample and a learning dimension measurement image corresponding to the learning captured image, and
a contrast between the measurement pattern image and a non-measurement pattern image present in vicinity of the measurement pattern image in the learning dimension measurement image is improved compared to a contrast between the measurement pattern image and the non-measurement pattern image in the learning captured image, or in the learning dimension measurement image, the non-measurement pattern image in the learning captured image is removed.

12. The dimension measurement method according to claim 11, wherein
the computer system further includes an image conversion model creation unit configured to create the dimension measurement image conversion model,
the image conversion model creation unit includes a region segmentation unit, an image generation unit, and a learning unit,
the region segmentation unit of the image conversion model creation unit generates a label image segmented into a measurement pattern region that is a region of the measurement pattern image included in the learning captured image and a background region other than the measurement pattern region,
the image generation unit of the image conversion model creation unit creates, as the learning dimension measurement image, a pseudo captured image in which a pseudo measurement pattern image is generated in the measurement pattern region of the label image, and
the learning unit of the image conversion model creation unit learns the dimension measurement image conversion model using labeled training data that is a combination of the learning captured image and the pseudo captured image.

13. The dimension measurement method according to claim 12, wherein
the region segmentation unit of the image conversion model creation unit includes a dimension measurement edge detection unit, a region specification unit, and a region extraction unit,
the dimension measurement edge detection unit detects an edge of the measurement pattern image,
the region specification unit specifies a pattern boundary of the measurement pattern image by interpolating the detected edge, and
the region extraction unit extracts a region surrounded by the specified pattern boundary as the measurement pattern region.

14. The dimension measurement method according to claim 13, wherein
the computer system stores a dimension measurement recipe that is data representing a dimension measurement condition of the measurement pattern image,
the dimension measurement edge detection unit includes a dimension measurement edge learning unit and a dimension measurement edge inference unit, and detects an edge of the measurement pattern image in a dimension measurement cursor defined in the dimension measurement recipe by interactive machine learning,
the dimension measurement edge learning unit learns a learnable model by labeled training data indicating an edge of the measurement pattern image,
the dimension measurement edge inference unit performs inference of the edge of the measurement pattern image in the dimension measurement cursor by the learnable model, and
the dimension measurement edge learning unit learns the learnable model by deleting, from among edges of the measurement pattern image inferred by the learnable model, an edge of the measurement pattern image that deviates from a boundary of the measurement pattern image to obtain new labeled training data.

15. The dimension measurement method according to claim 12, wherein
the image conversion model creation unit further includes a region designation unit configured to designate a region in which the measurement pattern image included in the learning captured image is present.

16. The dimension measurement method according to claim 12, wherein
the computer system further includes an image generation model creation unit, and
the image generation unit of the image conversion model creation unit creates the pseudo measurement pattern image in the measurement pattern region of the label image by an image generation model created by the image generation model creation unit.

17. The dimension measurement method according to claim 16, wherein
the image generation model creation unit includes a region segmentation unit and a learning unit,
the region segmentation unit of the image generation model creation unit generates a label image segmented into a measurement pattern region that is a region of the measurement pattern image included in the learning captured image and a background region other than the measurement pattern region, and
the learning unit of the image generation model creation unit learns the image generation model using labeled training data that is a combination of the label image and the learning captured image or an image obtained by performing image processing of emphasizing the measurement pattern image on the learning captured image.

18. The dimension measurement method according to claim 17, wherein
the region segmentation unit of the image generation model creation unit includes a dimension measurement edge detection unit, a region specification unit, and a region extraction unit,
the dimension measurement edge detection unit detects an edge of the measurement pattern image,
the region specification unit specifies a pattern boundary of the measurement pattern image by interpolating the detected edge, and
the region extraction unit extracts a region surrounded by the specified pattern boundary as the measurement pattern region.

19. The dimension measurement method according to claim 18, wherein
the computer system stores a dimension measurement recipe that is data representing a dimension measurement condition of the measurement pattern image,
the dimension measurement edge detection unit includes a dimension measurement edge learning unit and a dimension measurement edge inference unit, and detects an edge of the measurement pattern image in a dimension measurement cursor defined in the dimension measurement recipe by interactive machine learning,
the dimension measurement edge learning unit learns a learnable model by labeled training data indicating an edge of the measurement pattern image,
the dimension measurement edge inference unit performs inference of the edge of the measurement pattern image in the dimension measurement cursor by the learnable model, and
the dimension measurement edge learning unit learns the learnable model by deleting, from among edges of the measurement pattern image inferred by the learnable model, an edge of the measurement pattern image that deviates from a boundary of the measurement pattern image to obtain new labeled training data.
